(19) United States
(12) Patent Application Publication
(10) Pub. No.: US 2015/0287051 A1
(43) Pub. Date: Oct. 8, 2015

(54) SYSTEM AND METHOD FOR IDENTIFYING GROWING COMPANIES AND MONITORING GROWTH USING NON-OBVIOUS PARAMETERS

(71) Applicants: Mirza Zaullah Baig, Great Falls, VA (US); Raheel Zia, Los Altos, CA (US); Iftikar Ahmed, Greenwich, CT (US)

(72) Inventors: Mirza Zaullah Baig, Great Falls, VA (US); Raheel Zia, Los Altos, CA (US); Iftikar Ahmed, Greenwich, CT (US)

(73) Assignee: Cascades Investment Partners, LLC, Great Falls, VA (US)

(21) Appl. No.: 14/248,320

(22) Filed: Apr. 8, 2014

(51) Int. Cl. G06Q 30/02

(52) U.S. Cl. CPC G06Q 30/0201

(57) ABSTRACT

The focus of this invention is to provide an efficient growth analytical system for companies. The inventive system taught here describes a ranking system that ranks companies based on a combination of factors including non-obvious parameters corresponding to the type of company whose growth is being analyzed. The ranking is based on weightages associated with different data points, the data points being indicative of growth parameters. Companies are ranked and re-ranked based on appropriate data point and/or time period selection by a user. The users are provided “user handles” to tweak ranking per their desired criteria. Such a system would help investors and key players to make better business decisions when analyzing smaller non-listed companies.

### CROSS-REFERENCE TO RELATED APPLICATIONS

NONE

### BACKGROUND OF THE INVENTION

1. Field of Invention

The invention is directed to a decision support system which uses analytics to help user's measure growth and performance of companies.

2. Background of the Invention

There are two fundamental problems that investors face today. First, they find it very difficult to identify growing private companies. Second, it is very difficult for them to ascertain the true overall value of a company so as to make an informed decision about investing.

Existing valuation techniques and or methods use purely financial metrics when additional inputs into valuating a private company exist. For example, operating performance and non-monetary measures are excellent indicators that help ascertain the true overall value of a company. These are largely ignored due to lack of an existing system that can collect, store, calculate, analyze data from disparate obvious and non-obvious sources and present decision support information in an intuitive easy to use interface.

For example, valuations are currently provided by various financial professionals, but the process tends to be manual, time consuming, and the results vary widely as no standardized valuation methodology is adopted across the profession. For example, as a private company can have multiple investors, it is not uncommon for each investor to value the company differently, which creates ambiguity and hinders the investment decision making process.

Moreover, various techniques of valuing a private company involve a selection of publicly traded peer companies. Generally, the individual conducting the valuation uses a manual method of determining the peers. The method can be based on the individual's expertise with the industry, use of industry classification schemas, or searching in a financial information product or the Internet using general terms. Unfortunately, these methods tend to lead to inconsistent results. The inconsistent results can be caused by individuals not having complete information on actual peer comparison, using industry classifications that identify peer companies that aren't truly comparable, or individual decision making being biased by selecting companies that have higher or lower valuation multiples, intentionally or unintentionally.

Several techniques of valuing private companies also include the use of merger or acquisition (M&A) data of comparable companies. While these techniques can be relevant in determining valuations when a company is being acquired, these techniques can provide inaccurate results for the current valuation of a company. The reason for the potential inaccuracy relates to the timing of the M&A information. In particular, the M&A information used in the analysis may occur over many different economic cycles, and these cycles may not be representative of the current cycle. As the purpose of a valuation is to derive the value of the company as if it were to trade today, use of merger and acquisition data can mislead current investors.

Another common technique for valuing private companies is to calculate the current value of the projected future cash flows. This is a reliable method for companies where it is possible to accurately predict the future revenue growth and operating margins of a company out five to ten years. However, for many privately held companies, the accuracy of these projections can be very low and produce misleading results. The projections also suffer from the manual process of intentional or unintentional bias

In addition, there are various systems in the market which help investors make investment decisions based on monetary parameters. However, there is no system that facilitates analyzing data more efficiently by combining various obvious and non-obvious growth parameters.

Decision makers, investors, etc. need a system which shows a company's performance in real time, not based on only monetary parameters but also a combination of other growth parameters such as social media, jobs data, intellectual property data, web traffic data, ad spending, compliance data, etc. A system is required wherein by using repetitive application of algorithms over a combination of various obvious and non-obvious growth parameters, true organic growth of a company is calculated.

Moreover such a system doesn't exist wherein one can review and extract information from startup non-listed companies. It is a known fact that financial information for smaller startup companies is not easily available. This makes it difficult to pursue business decisions related to such companies. For this reason, it would be beneficial to analyze the company across various factors including non-obvious growth parameters.

Accordingly, there is a need for a user driven self-learning repetitive method to process information related to companies based mostly on data points corresponding to non-obvious growth parameters. For instance, a user may be interested in a company's growth in one or many data sources such as social media, jobs, IP, web traffic, etc. Therefore, there is also need for a flexible system that ranks companies based on individual or a combination of data points.

A system is thus presented that collects, stores, calculates, analyzes data from disparate obvious and non-obvious sources and presents decision support information in an intuitive easy to use interface so as to help ascertain the true overall growth and value of a company and to make an informed investment decision.

### SUMMARY OF THE INVENTION

The invention teaches a method and system for identifying growth rate in companies and ranking them. Data points are identified and company growth parameters are extracted for each data point. Company growth parameters are extracted from non-obvious data sources such as social media databases, jobs databases, IP databases, web traffic databases, news articles, compliance data etc. Growth rate is computed for each of the data points and weightages are assigned to each of the data points based on numerous factors. A score is then computed based on the combination of growth rate and weightages of all data points. Ranks are assigned to each company based on the computed score. The invention also facilitates the computation of re-ranking based on selection of interested data points. The user is also provided a “user handle” that helps tweak the ranking algorithm based on user input.

### BRIEF DESCRIPTION OF DRAWINGS

FIG. 1 is a schematic diagram of a computer device (Prior Art).

FIG. 2 is a network drawing illustrating the distributed network environment of the system.

FIG. 3 is a schematic drawing illustrating a schematic view of the interoperability of the system.

FIG. 4 is a flow diagram depicting a filtration process.

FIG. 5 is a flow diagram illustrating an extraction process.

FIG. 6 is a flow diagram illustrating a scoring categorization process.

FIG. 7 is a flow diagram illustrating a ranking process.

FIG. 8 is a table view of various input parameters in the ranking process.

### DETAILED DESCRIPTION OF THE INVENTION

The inventive system consists of data extraction software, and a database that stores the extracted information for non-listed startup companies although it is not limited to the same. It also consists of a real time monitoring software and ranking mechanism corresponding to certain rules and algorithms. The performance analytics system is flexible in that it allows the user to analyze startup non-listed companies' growth based on appropriate data point selection in selected periods.

Financial information for non-listed companies is not easily available publicly. This makes it difficult for an investor to make business decisions related to that company. For this reason, it would be more beneficial to analyze the company in terms of non-obvious parameters such as “social media” data, “job” data, “intellectual property” data, “news” data, “web traffic” data, etc. Moreover, the inventive system benefits smaller non-listed companies which are not fully aware of venture capitals and investment funding by bigger companies. The proposed system in that sense will facilitate not only the investors towards making investment decisions but also smaller non-listed companies from identifying potential investors.

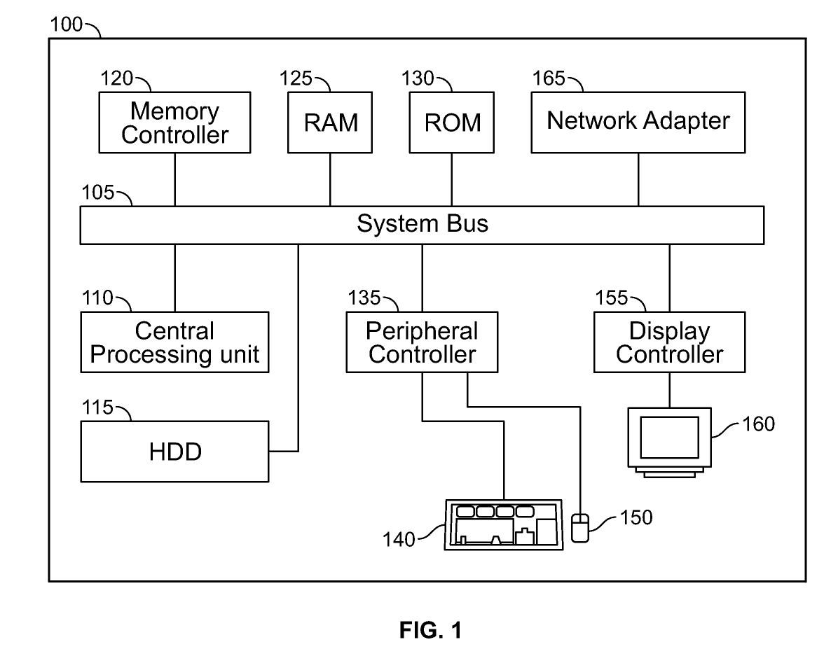

FIG. 1 depicts an exemplary computing system 100 for use in accordance with herein described system and methods. The computing system 100 is capable of executing software, such as an operating system (OS) and a variety of computing applications stored thereon. The operation of computing system is controlled primarily by computer readable instructions, such as instructions stored in a computer readable storage medium, such as a hard disk drive, optical disk drive (e.g. CD or DVD), solid state drive (e.g. USB drives), or the like. Such instructions may be executed within a Central Processing Unit (CPU) 110 to cause the computing system 100 to perform operations. In many known computer servers, workstations, personal computers, and the like, CPU is implemented in an integrated circuit called a processor.

It is appreciated that, although exemplary computing system 100 is shown to comprise a single CPU 110, such description is merely illustrative as computing system 100 may comprise a plurality of CPUs. Additionally, computing system 100 may exploit the resources of remote CPUs (not shown), for example, through communications network 165 (e.g. Internet) or some other data communications means.

In operation, the CPU fetches, decodes, and executes instructions from a computer readable storage medium such as a hard disk drive (HDD) 115. Such instructions can be included in software such as an operating system (OS), executable programs, and the like. Information, such as computer instructions and other computer readable data, is transferred between components of computing system 100 via the system's bus architecture.

Memory devices coupled to CPU can include random access memory (RAM) 125 and read only memory (ROM) 130. Such memories include circuitry that allows information to be stored and retrieved. ROMs generally contain stored data that cannot be modified. Data stored in RAM can be read or changed by CPU or other hardware devices. Memory controller may control access to RAM and/or ROM. Memory controller 120 may provide an address translation function that translates virtual addresses into physical addresses as instructions are executed. Memory controller may also provide a memory protection function that isolates processes within the system and isolates system processes from user processes. Thus, a program running in user mode can normally access only memory mapped by its own process' virtual address space; it cannot access memory within another process' virtual address space unless memory sharing between the processes has been set up.

In addition, computing system 100 may contain peripheral controller 135 responsible for communicating instructions using a system bus 105 from CPU to peripherals, such as keyboard 140, and mouse 150. An example of a peripheral bus is the Peripheral Component Interconnect (PCI) bus.

The user interface display 160, which is controlled by display controller 155, can be used to display visual output and/or presentation generated by or at the request of computing system 100. Such visual output may include text, graphics, animated graphics, and/or video, for example. Display 160 may be implemented with a CRT-based video display, an LCD-based flat-panel display, gas plasma-based flat-panel display, touch-panel, or the like. Display controller 155 includes electronic components required to generate a video signal that is sent to display 160.

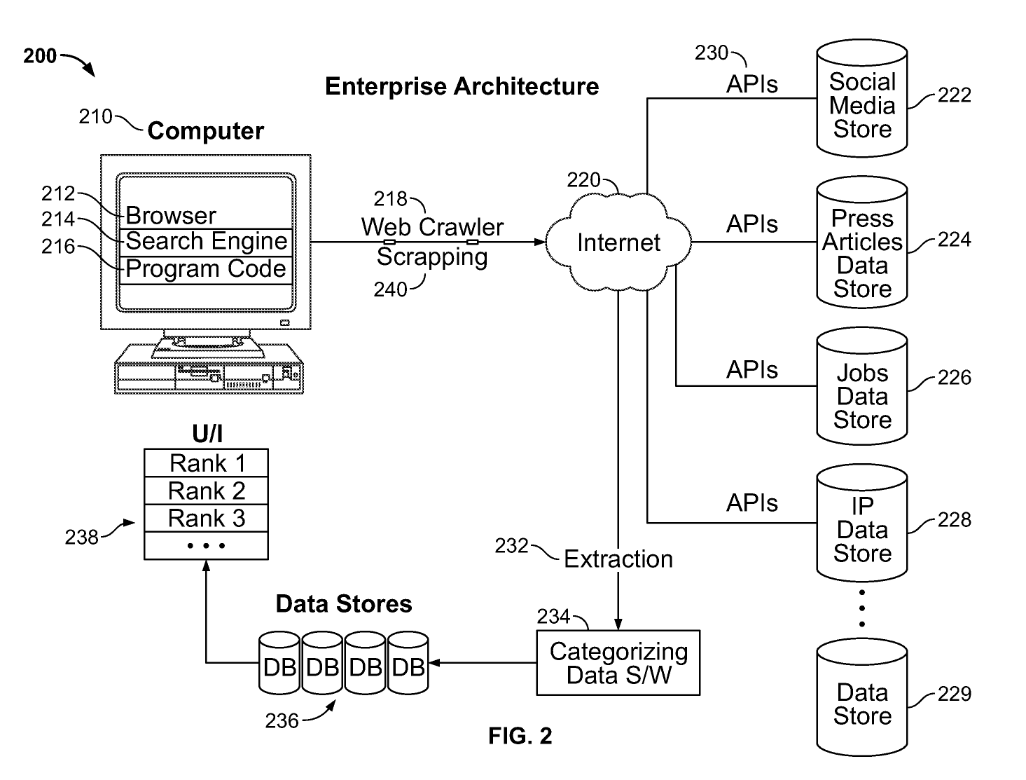

Turning to FIG. 2, the memory of computing system 210 is configured to include a browser 210 that is used to request and receive information from the external communication network (e.g. Internet) 220. Although only one computing system 210 is shown in FIG. 2, the system can support multiple computing systems.

Further, the computing system 210 may contain network adapter which may be used to couple computing system 210 to an external communication network 220, which may include or provide access to the Internet. Communications network 220 may provide user access for computing system 210 with means of communicating and transferring software and information electronically. Additionally, communications network 220 may provide for distributed processing, which involves several computers and the sharing of workloads or cooperative efforts in performing a task. It is appreciated that the network connections shown are exemplary and other means of establishing communications links between computing system 210 and remote users may be used.

It is appreciated that exemplary computing system 210 is merely illustrative of a computing environment in which the herein described systems and methods may operate and does not limit the implementation of the herein described systems and methods in computing environments having differing components and configurations, as the inventive concepts described herein may be implemented in various computing environments using various components and configurations.

The communication network 220 can include various devices such as routers, servers, and switching elements connected in an Intranet, Extranet or Internet configuration. In one embodiment, the computer system 210 accesses the one or more disparate data sources (e.g. 222, 224, 226, 228, and 229) from the communication network (e.g. Internet) 220 via an application programmable interface (API) 230. In another embodiment, the communication network 220 employs wireless communication protocols. In yet other embodiments, the communication network 220 employs a combination of wired and wireless technologies.

As further shown in FIG. 2, the disparate sources of data are configured to send requested web pages to the browser 212 of the computing system 210 in response to a web page request. The web server communicates with the web browser 212 using one or more communication protocols, such as HTTP (Hyper Text Markup Language). In one embodiment, the web server is configured to include the Java 2 Platform, Enterprise Edition (‘J2EE’) for providing a plurality of screens included in a user interface displayed on the browser 212.

The web server provides a run-time environment that includes software modules for valuing privately-held companies. As further shown in the FIG. 2 example, in one embodiment, the run-time environment may include a plurality of program codes/modules 216, where program codes may be a target module for accessing and gathering information associated with a privately-held company, a business module for determining business comparability of publicly-traded companies to the privately-held company, a finance module for determining financial comparability of publicly-traded companies to the privately-held company, an analysis module for computing a valuation of the privately-held company and confidence rating of the privately-held company, and a display module for displaying the computed valuation value and confidence rating on the browser of the access device in response to a request. Details of the program codes configured in the run-time environment are discussed in further detail below.

As shown in FIG. 2, the system 200 includes a data store 236 that is utilized by software module 234 to access and store information relating to private company valuations. In one embodiment, the data store 236 is a relational database. In another embodiment, the data store 236 is a directory server, such as a Lightweight Directory Access Protocol (‘LDAP’) server. In yet another embodiment, the data store 236 is a configured area in the non-volatile memory of the server. Although the data store 236 shown in FIG. 2 is connected to the network 220, it will be appreciated by one skilled in the art that the data store 236 can be distributed across various servers and be accessible to the server over the network 220, or alternatively, coupled directly to the server, or be configured in an area of non-volatile memory of the server.

It should be noted that the system 200 shown in FIG. 2 is one embodiment of the disclosure. Other system embodiments of the disclosure may include additional structures that are not shown, such as secondary storage and additional computational devices. In addition, various other embodiments of the disclosure include fewer structures than those shown in FIG. 2. For example, in one embodiment, the disclosure is implemented on a single computing device in a non-networked standalone configuration. Data input is communicated to the computing device via an input device, such as a keyboard and/or mouse. Data output of the system is communicated from the computing device to a display device, such as a computer monitor.

FIG. 2 further describes the computer-based system for valuing a privately-held company, at least in part, on publicly traded companies. The system 100 is configured to compute a valuation for a privately-held company using a weighted average valuation multiple and a weighted average total return value associated with publicly traded companies. A confidence rating of the computed valuation is also computed. A computer 210 includes applications stored on a browser application 212 in which a particular user may use a particular search engine 214 (such as Google, Yahoo!, Microsoft, and the like). The search engine 214 crawls, using a web crawler 218, the Internet 220. Available to the public on the Internet, there are disparate data stores that contain information that is accessible from APIs 230 and viewed in a public profile.

For example, social media data stores 222, “Jobs” 226 from sources such as Monster, Dice, Indeed, etc., “Press Articles” 224 from sources such Alexa, ‘Google alerts’ data, and many other sources, and “intellectual property” data store 228 from sources such the USPTO, EPO, JPO, etc.

The one or more data stores available, illustrates the one or more non-obvious data sources, may enable an extraction unit that is tasked to extract data from the one or more non-obvious data sources which are publicly accessible and disclosed to the user. For example, Company ‘X’ has a public profile page in one or more types of social media databases 222, where the public profile page includes press releases, trending news, and other information that Company ‘X’ deems relevant to disclose. Other types of social media databases, where company information may be extracted from include social networking sites such as Facebook, Twitter, Orkut, LinkedIn, and the like. It is appreciated that exemplary non-obvious data sources is not limited to the illustration depicted in the herein described systems and rather provide a general understanding of the numerous non-obvious disparate data sources.

Social media data store 222 could be, for example, the “number of likes”, the “number of followers”, and the “number of shares” etc. on websites such as Facebook, Twitter, and the like. Social media is an important factor for investors wanting to invest in companies wherein public sentiments are very important. For instance, investors wanting to invest in a designer label will want to know what kind of fan base it has. One simple way of looking at it would be to go to the social media page to see current popularity. However, this may not be a true indicator of growth. Therefore, repeatable analysis of metrics over periods of time is required to gauge actual organic growth. This can be gauged by evaluating the number of followers on Twitter, or number of fans on Facebook, number of likes on Facebook, etc. over user defined periods of time.

Jobs data 226 could be, for example, the “number of jobs posted”, “number of employees”, “retention data”, etc. on sources such Monster, Indeed, Simply Hired, LinkedIn, etc. Evaluating the number of job postings, number of employees, etc. over various user driven periods of time could be used to find out how the company fares in terms of employee growth. It is common that growing companies increase their workforce frequently.

Web traffic data (not shown, but included in the disparate data sources) could be, for example, the “reach”, “unique visitors”, “daily visitors”, etc. on sources such as Alexa, Quant cast, Compete, etc. For example identifying growth in web traffic data over user defined periods of time can help a user gauge how the popularity (and in most cases, growth) of a company has increased.

Intellectual property data 228 could be, for example, the “number of patents”, “number of applications”, “number of licensees”, etc. obtained from public information from the United States Patent and Trademark Office (USPTO), European Patent Office (EPO), Japanese Patent Office (JPO), and other global patent offices, where public information may be accessible. Intellectual property is one of the main assets of a company. Information about a company's IP can make or break an investment decision. For example, there would be an increase of IP weightage based on whether the company has a large number of patents or the weightage may decrease in the case that the company has many patent litigation cases against it.

For the sake of brevity, data may be obtained from other non-obvious data sources, included, but not limited to web traffic data source, travel data source, business registration data source, awards data source, real estate data source, compliance data source, tax filing data source, press release and news data source, advertisement spending data source, hosting data source, events participation data source, and mobile application purchasing market data source and the like. It is understood that the exemplary embodiment is an illustrative example, but not limited to the embodiment as described in the disclosure.

Once the data is received, it is then categorized 234 based on an extraction 232 mechanism. When the data is categorized, the date is then stored in a distributed data storage 236. The user is then able to rank the parameters 238 via a user interface.

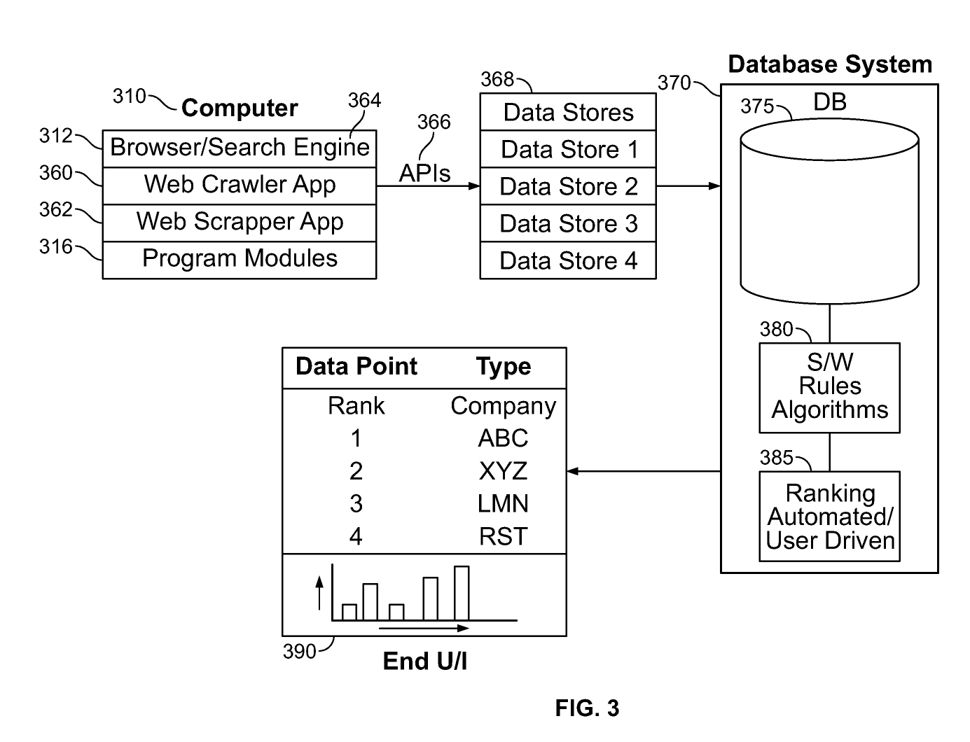

Turning to FIG. 3, the database system includes various databases 370 with rules engine 380 configured to it and then a user driven ranking mechanism 385. The data is then displayed to the end user 240.

As previously described in the figures above, the inventive system extracts company information from publicly available databases (as described above in FIG. 2). In one embodiment, the company names are extracted and then placed in a filtration process database, where the extracted data is scrubbed and mined, to identify startup or smaller non-listed companies. The company names are extracted either manually or using an automated process. For instance, company names can be retrieved from readily available public database (e.g. CrunchBase, Bloomberg, etc.), where certain rules are determined to differentiate the listed public companies from the smaller non-listed companies. Factors such as revenue, number of employees, geographical location, etc., can be used as variables or used specified parameters in the filtration process.

Although company information may be extracted manually, it would not be feasible when the data is very large or when the list of companies from which information is to be extracted is very large. Company information may also be extracted using crawlers, spiders, and other well-known scraping techniques. The most common way of extracting company information would be to use crawlers. Crawlers are web programs (also known as spiders or bots), that visit websites and read through their pages and information therein in order to create entries into their respective search engine index. A crawler typically starts with the list of URLs, also known as seeds, to find and catalog data including all hyperlinks, into its index. Well-known search engines such as Google, Yahoo, and Bing use some of the popular current crawlers. Another common technique is web scraping which is a computer software technique of extracting information from a plurality of web pages. The concept of web scraping is closely related to web indexing, which indexes information on the web using a bot or web crawler as do most search engines which have adopted this as a universal technique. In contrast, web scraping focuses more on the transformation of unstructured data on the web, typically in HTML format, into structured data that can be stored and analyzed in a central local database. Web scraping is also related to web automation, which simulates human browsing using computer software. Company information may be extracted using various APIs comprising of programming instructions and standards for gaining access to web based applications. An API specifies how software components interact with each other and are used to gain access to databases, hard disk drives, video cards, etc. Company information can also be extracted using various web scraping techniques. Web scraping is the software method of automatically extracting information from web pages. It is similar to crawling, which is adopted by most search engines. Web scraping emphasizes more on conversion of unstructured data into structured data that can be stored on local databases.

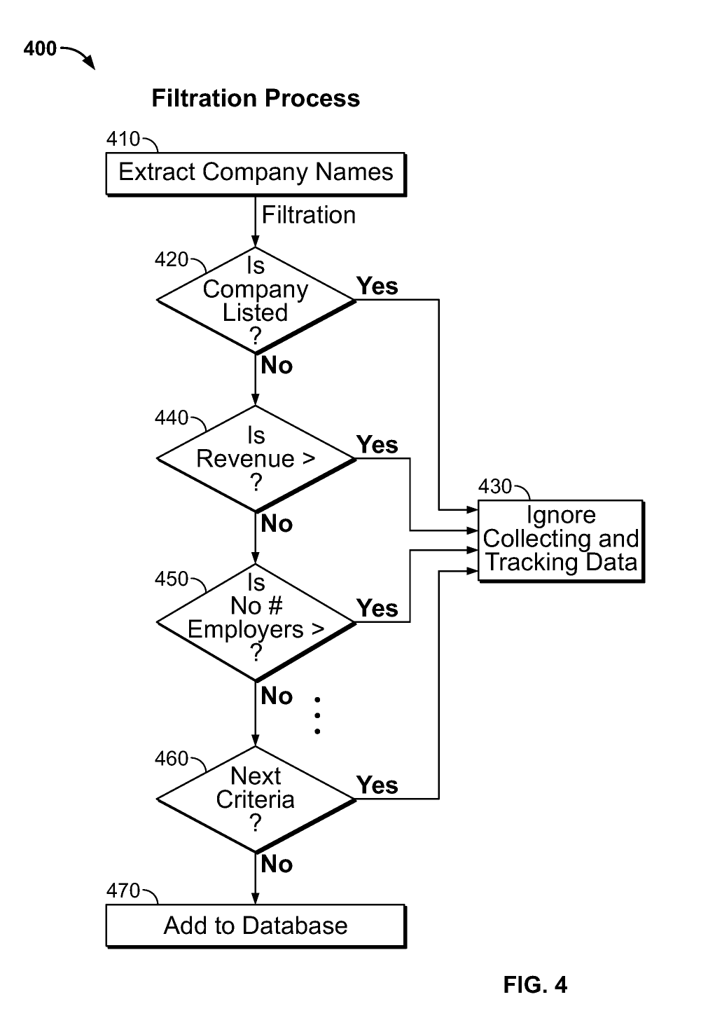

FIG. 4 illustrates a filtering process 400, where the crawler extracts the company names (step 410). It then makes a determination as to whether the company is listed (step 420). If the company is listed, then the filtration process ignores the collection and tracking of the targeted data (step 430), otherwise it then determines whether the company discloses its revenues (step 440). If so, then the filtration process ignores the collection and tracking of the targeted data (step 430). Otherwise, it then determines the number of employees (step 450). If so, then the filtration process ignores the collection and tracking of the targeted data (step 430). If not, it proceeds to the next criteria (step 460). Once the filtration process has extracted the informational data from the disparate sources of data by crawling and scraping the data, it adds the user specified filters to the database (step 470).

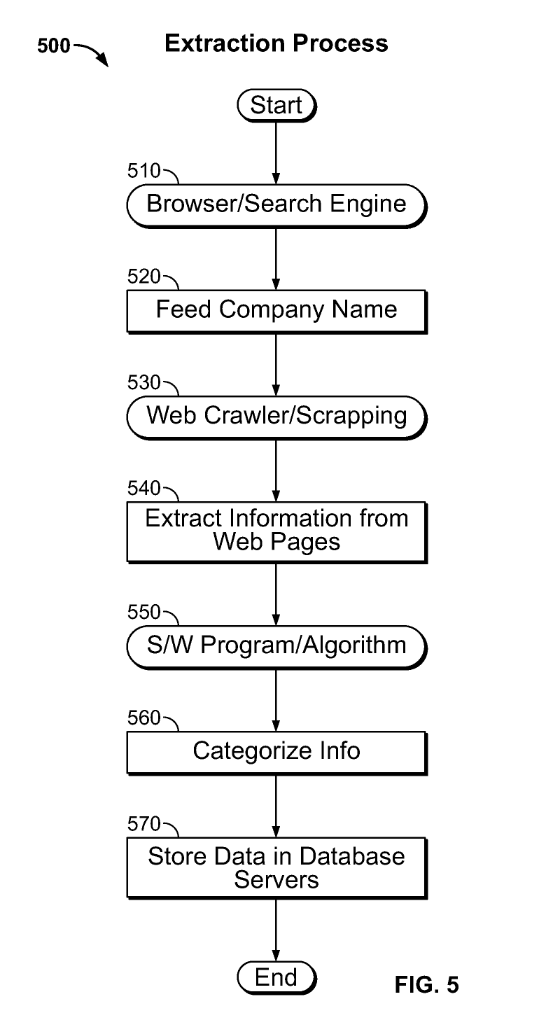

FIG. 5 illustrates an extraction process 500 where the extraction process is user driven to receive company names 520 based on the informational data that is crawled from the search engine 510. The web crawler 530 then returns the extracted information from the web pages 540. Based on the software program algorithm 550, it then categorizes the information 560 and then stores the categorized information in database servers 570.

FIG. 4 and FIG. 5 describe a typical workflow of crawling data and storing it in a database. A crawler starts by parsing a web page and makes note of any hyperlinks on that page, and then parses the webpages corresponding to the hyperlinks and so on continuously. It is required to have the crawler parse data in an efficient way, meaning it should intelligently choose which page to parse next. Since the web is expanding each and every day, it is important for the crawler to download the most relevant pages. Cost and time are major concerns while using a crawler. Various algorithms could be used such that the crawler parses the most relevant pages on the web. Some of the known crawler algorithms are PageRank algorithm, breadth-first search, depth-first search, HITS algorithm, etc.

In one embodiment, the crawling is done using an Application Programming Interfaces known as APIs. API's from data sources like Facebook, Simplyhired, LinkedIn and Alexa etc., could be used. Programming code could be developed on frameworks such as .Net framework and using languages such as C# to request APIs from a particular data source. The programming code then receives the response from the API which could be in the form of XML, JSON etc. The data received is then pushed to the respective data tables in the database.

Some data sources may not provide the application programming interfaces or in some instances using API's may not apply to the context of extraction. Scraping techniques could be used in this case.

Scraping of the data will be useful in these scenarios where the programming code is actually accessing the HTML source code available at the client side. The programming code could be written in a particular way to get Document Object Model (DOM) elements. The programming code retrieves the useful data from the DOM elements. The data retrieved from the scraping is then pushed to the respective data tables in the database. There are many popular databases in the market like Oracle, SQL server, MongoDB, etc. which can be used to store the extracted data. Most companies are moving to Big Data to store large amounts of data. Database technologies like Hadoop could be used to store data more efficiently.

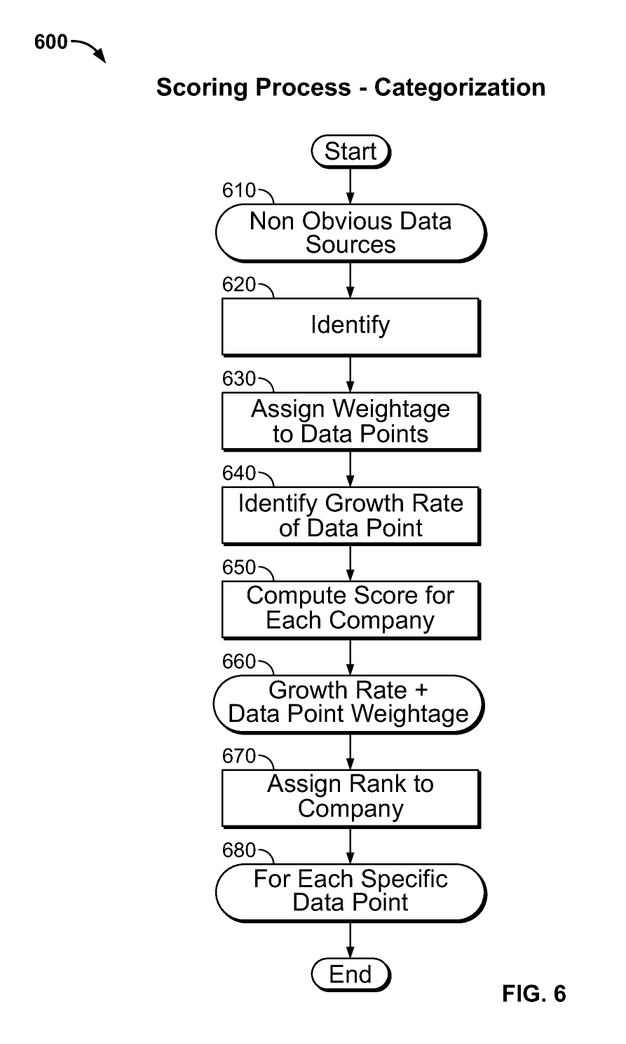

FIG. 6 illustrates a scoring process 600. Based on the data scraped from the disparate sources, the process 600 takes the mined data from the non-obvious data sources 610 and then identifies the type of information that is relevant to a user 620. The process allows the users to assign some type of weightage to the data points collected from the disparate data sources 630. The user is then able to identify the growth rate of the data point and factor the information into the valuation of a targeted company 640. A score is computed for each company 650. That score and the weightage points are then calculated together (as described further below) 660. Ranking is then assigned to each company 670 and for each specific data point 680

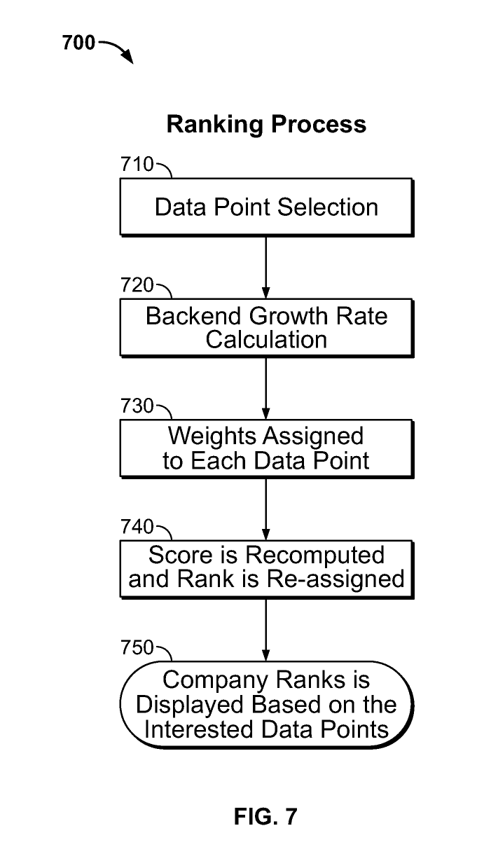

FIG. 7 illustrates a ranking process 700, where data points are selected 710. It then calculates the backend growth rate 720 and then weight is assigned to each data point 730. The score is then recomputed and ranking is re-assigned 740 and then the company ranks are displayed based on the point of interest 750.

The inventive performance analytics system also consists of a ranking process, wherein ranking is based on the growth rate of different data points. Data points are factors like social media, jobs data, intellectual property data, news data, ad spending data, etc. Each data point is given a weightage and this weightage is made to be user driven. The weightage can be made to be flexible in the sense that a user can change the weightage for a particular data point based on the sector or industry being reviewed. For each data point and within a particular period of interest the growth rate will be calculated at the time of crawl or at regular intervals. Using growth rate and the weightage, the company score will be calculated using applicable formulas and calculations. Finally a rank is assigned to each company across different data points. A user can use the inventive system to compute ranking for particular data points instead of all the data points; this is discussed further in the next section. One non limiting method of calculating growth rate is described below and subsequent company rank is shown below.

### Growth Rate:

GR_{DP}=(GP_{V1}_{_{—}}_{DP}−GP_{V2}_{_{—}}_{DP})/GPᵥ₂_{_{—}}_{DP})*100

GR_{DP}=Growth rate of a company for a specific data point DP. GR_{DP} can be calculated for each different data point on different periods.

GP_{V1}_{_{—}}_{DP}=Value of a company growth parameter on a specific period for a data point.

GP_{V2}_{_{—}}_{DP}=Previous value of a company growth parameter GP_{VlDP}.

Below are some exemplary period values of GP_{V1}_{_{—}}_{DP} and GP_{V2}_{_{—}}_{DP} For example if period value is “Daily” then GP_{V1}_{_{—}}_{DP} is end of day value of the previous day and GP_{V2}_{_{—}}_{DP} is end of day value of the day prior to the previous day.

| Period | GP_{V1}_{_{—}}_{DP} | GP_{V2}_{_{—}}_{DP} |
|---|---|---|
| Daily | Value on Day-1 | Value on Day-2 |
| Weekly | Value on Day-1 | Value on Day-7 |
| Monthly | Value on Day-1 | Value on Day-30 |
| Quarterly | Value on Day-1 | Value on Day-90 |

### Company Rank

Score=(GR_{DP}_{_{—}}₁*W_{DP}_{_{—}}₁)+(GR_{DP}_{_{—}}₂*W_{DP}_{_{—}}₂)+ . . . (GR_{DP}_{_{—}}_{N}*W_{DP}_{_{—}}_{N})/N

N—Number of data points used

GR_{DP}—Growth rate of specific data point

W—Weightage of specific data point with respect to the other data points based on user selection.

The growth rate and ranking can be calculated for a particular time period, this helps the user to make a better judgment on how much growth the company has seen in terms of a specific one or more data points. For example, a user wants to find out a list of companies based on their growth in intellectual property assets over a user defined period of time. The user more specifically wants to know how various companies in a domain of his liking in a time period of his choice fared in terms of patent activity.

Each data point will be assigned with a high and low weightage number when compared to each other data points available based on user selection. The rank will be assigned to each company based on the scores computed for a given period. This kind of ranking mechanism will help a user determine growth in particular domain or industry. It further allows a user to identify data points of interest and complete a search based on that. In this way the invention further allows for re-ranking companies based on user's selection of interested data points. For instance, let's say a user is interested in ranking a company based on social media, or to be more specific the number of followers on Twitter. In this case, a score specific to appropriate data point corresponding to the Twitter data source for number of followers is computed and a rank is assigned accordingly. One data point may correspond to many non-obvious data sources, for example a social media data point may relate to Facebook, Twitter, Orkut, and other related data sources and the user handles allow users to define specific sub data points across each of the major data points.

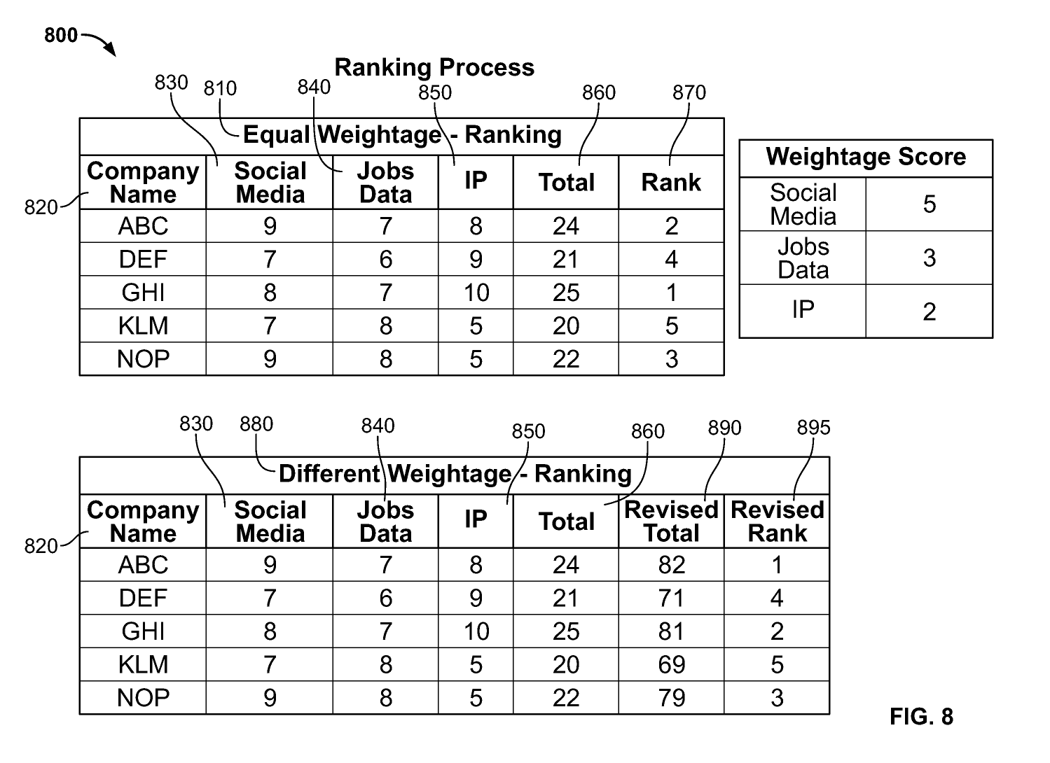

FIG. 8 illustrates the ranking process 800 as previously described in FIG. 6 and FIG. 7, where a ranking and re-ranking is disclosed in assigning user-specified weightages. For example, the equal weightage ranking table 810 depicts the company name 820, the various non-obvious disparate data stores, where data is scraped from Social media store 830, Jobs data store 840, and IP data store 850. A total score 860 is then accumulated for each company and is then assigned a rank 870. Initially, when all data points are given equal weightage company “GHI” is ranked first. When weightages are adjusted indicating a higher preference for specific non-obvious data store, the new weightages are then applied to each data point as shown in table 880, the resulting scores and rankings change as seen in the revised total 890 and revised rank 895. For example, company ABC is re-ranked as the number one company.

As further disclosed in FIG. 8, the figure further illustrates two typical ranking scenarios, first wherein ranking is calculated with equal weightage and second wherein the ranking is calculated using different user defined weightage scores. The table, “Equal Weightage Ranking”, lists five companies and their corresponding data point scores for Social Media, Job Data, and Intellectual Property. The total score is then summed up, and a rank is assigned to them. The table, “Different Weightage Ranking”, lists the same companies and their corresponding data point scores, and total score which are similar to those in the previous table, however there are added columns, namely “Revised Total” and “Revised Rank”, which is computed based on user defined weightage scores. The “Revised Total” is calculated based on weightage scores seen in table, “Weightage Scores”. In this instance, Social Media is given a weightage score of 5, Jobs data is given a weightage score of 3, and IP a weightage score of 2. The revised total is calculated by multiplying the score of the 3 data points with their weightage scores and summing them up to get the Revised Total. For example the revised total for company “ABC” is 9*5+7*3+8*2, which is equal to 82. The revised totals are calculated similarly for other companies, and a Revised Rank is assigned to each one of them.

In one embodiment, the Weightage Score can be selected by users themselves, wherein a user gives weightage to data points he/she thinks is more appropriate in determining growth of a particular company. In another scenario, the Weightage Score can be automatically assigned by the ranking system, which uses some intelligence to assign scores. In one example, the system could gauge what interests the user based on his profile or based on a filtering session. The system could then use the collected data to intelligently assign Weightage Scores to various data points.

Moreover the company ranking system taught in the patent is an intelligent system and can be based on various algorithms and use various data sources. For instance, the ranking algorithm can be an intelligent process based on machine learning or other aspects of artificial intelligence. For example, the system can be programmed to identify user characteristics based on answers to certain questionnaire. Based on the user characteristics identified the ranking system or method can intelligently assign weightage to different data points and present to a user a set of closer matching companies and their rankings.

Various features of the system may be implemented in hardware, software, or a combination of hardware and software. For example, some features of the system may be implemented in one or more computer programs executing on programmable computers. Each program may be implemented in a high level procedural or object-oriented programming language to communicate with a computer system or other machine.

Furthermore, each such computer program may be stored on a storage medium such as Read Only-Memory (ROM) readable by a general or special purpose programmable computer or processor, for configuring and operating the computer to perform the functions described above.

The preceding description is given merely by way of illustration only and not in limitation of the invention and that various modifications may be made thereto without departing from the spirit of the invention as claimed.

What we claim are:

1. A computer-implemented method, executed by a processor device, for performing a market data analysis by identifying targeted company growth based on both obvious and non-obvious factors, the method comprising:
identifying one or more parameters by a user, wherein said one or more parameters are configured to include a growth rate value;
retrieving search results associated from the one or more parameters from one or more non-obvious data sources and determining a ranking score based on the one or more parameters, wherein the ranking score ranks the one or more non-obvious data source;
associating the ranking score of the one or more non-obvious data source to one or more companies targeted for market analysis;
extracting one or more company growth parameters for each data point corresponding to the one or more non-obvious data source, wherein the non-obvious data source may include one or more disparate data sources;
determining the growth rate for one or more data point associated with one or more non-obvious data source;
assigning a weightage for one or more data point associated with the one or more non-obvious data source;
for each company targeted for market analysis, calculating a score based on a combination of growth parameter and one or more weightage for each data point;
assigning a rank to each company based on the computed score;
selecting one or more data point; and
transmitting to the user a re-ranking of the targeted company based on selection of interested data points.

2. The method of claim 1, wherein the company growth parameters is extracted by a search engine crawler, extracting information about a targeted company.

3. The method of claim 2, wherein the company growth parameter includes a value based on a specific period for the data point.

4. The method of claim 2, wherein the company growth parameter includes a previous value.

5. The method of claim 3, wherein the growth rate value is calculated for each different data point on a different period of time.

6. The method of claim 1, wherein the non-obvious data source includes one or more social media data source, jobs data source, intellectual property data source, web traffic data source, travel data source, business registration data source, awards data source, real estate data source, compliance data source, tax filing data source, press release and news data source, advertisement spending data source, hosting data source, events participation data source, and mobile application purchasing market data source.

7. The method of claim 1, wherein the one or more data points includes information from the one or more disparate data sources.

8. The method of claim 1, wherein each data point may correspond to one or more instances of one or more non-obvious data sources.

9. The method of claim 8, wherein each data point may correspond to one or more instances of one or more related non-obvious data sources.

10. A computer-implemented system for performing a market data analysis by identifying targeted company growth based on both obvious and non-obvious factors, the system comprising:
one or more processors;
one or more memory coupled to one or more processors;
identifying one or more parameters by a user, wherein said one or more parameters are configured to include a growth rate value;
retrieving search results associated with the one or more parameters from one or more non-obvious data sources and determining a ranking score based on the one or more parameters, wherein the ranking score ranks the one or more non-obvious data source;
associating the ranking score of the one or more non-obvious data source to one or more companies targeted for market analysis;
extracting one or more company growth parameters for each data point corresponding to the one or more non-obvious data source, wherein the non-obvious data source may include one or more disparate data sources;
determining the growth rate for one or more data point associated with one or more non-obvious data source;
assigning a weightage for one or more data point associated with the one or more non-obvious data source;
for each company targeted for market analysis, calculating a score based on a combination of growth parameter and one or more weight of each data point;
assigning a rank to each company based on the computed score;
selecting one or more data point; and
transmitting to the user a re-ranking of the targeted company based on selection of interested data points.

11. The system of claim 10, wherein the company growth parameters is extracted by a search engine crawler, extracting information about a targeted company.

12. The system of claim 11, wherein the company growth parameter includes a value based on a specific period for the data point.

13. The system of claim 11, wherein the company growth parameter includes a previous value.

14. The system of claim 12, wherein the growth rate value is calculated for each different data point on a different period of time.

15. The system of claim 10, wherein the non-obvious data source includes one or more social media data source, jobs data source, intellectual property data source, web traffic data source, travel data source, business registration data source, awards data source, real estate data source, compliance data source, tax filing data source, press release and news data source, advertisement spending data source, hosting data source, events participation data source, and mobile application purchasing market data source.

16. The method of claim 10, wherein the one or more data points includes information from the one or more disparate data sources.

17. The method of claim 10, wherein each data point may correspond to one or more instances of one or more non-obvious data sources.

18. The method of claim 17, wherein each data point may correspond to one or more instances of one or more related non-obvious data sources.

19. A non-transitory computer readable storage medium for performing a market data analysis by identifying targeted company growth based on both obvious and non-obvious factors comprising:
one or more computer-readable executable instructions stored in one or more memory coupled to one or more processor, when executed, executing instructions comprising:
identifying one or more parameters by a user, wherein said one or more parameters are configured to include a growth rate value;
retrieving search results associated with the one or more parameters from one or more non-obvious data sources and determining a ranking score based on the one or more parameters, wherein the ranking score ranks the one or more non-obvious data source;
associating the ranking score of the one or more non-obvious data source to one or more companies targeted for market analysis;
extracting one or more company growth parameters for each data point corresponding to the one or more non-obvious data source, wherein the non-obvious data source may include one or more disparate data sources;
determining the growth rate for one or more data point associated with one or more non-obvious data source;
assigning a weightage for one or more data point associated with the one or more non-obvious data source;
for each company targeted for market analysis, calculating a score based on a combination of growth parameter and one or more weight of each data point;
assigning a rank to each company based on the computed score;
selecting one or more data point; and
transmitting to the user a re-ranking of the targeted company based on selection of interested data points.

20. A computer-implemented system for identifying targeted company growth by ranking one or more parameters, the system comprising:
one or more processors;
one or more memory coupled to one or more processors;
identifying one or more parameters by a user, wherein said one or more parameters are configured to include a growth rate value;
retrieving search results associated with the one or more parameters from one or more non-obvious data sources and determining a ranking score based on the one or more parameters, wherein the ranking score ranks the one or more non-obvious data source;
associating the ranking score of the one or more non-obvious data source to one or more companies targeted for market analysis;
extracting one or more company growth parameters for each data point corresponding to the one or more non-obvious data source, wherein the non-obvious data source may include one or more disparate data sources;
determining the growth rate for one or more data point associated with one or more non-obvious data source;
assigning a weightage for one or more data point associated with the one or more non-obvious data source;
for each company targeted for market analysis, calculating a score based on a combination of growth parameter and one or more weight of each data point;
assigning a rank to each company based on the computed score;
selecting one or more data point; and
transmitting to the user a re-ranking of the targeted company based on selection of interested data points.
